(19) United States
(12) Patent Application Publication
(10) Pub. No.: US 2004/0035948 A1
(43) Pub. Date: Feb. 26, 2004

(54) Liquid transfer device

(76) Inventors: Antony Elmes Stuart, Coton Cambridge (GB); David Frank Moore, Cambridge (GB); Johathan Pearson, Mareh (GB)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/296,190

(22) PCT Filed: May 21, 2001
(86) PCT No.: PCT/GB01/02239

(30) Foreign Application Priority Data
May 22, 2000 (GB) 0012353.9

(51) Int. Cl. B05B 17/04

(52) U.S. Cl. 239/4; 239/102.1; 239/102.2; 239/596

(57) ABSTRACT

A disposable liquid storage and transfer device for storing and transferring a plurality of liquid droplets to one or more substrates, the device comprising a plurality of reservoirs for holding a respective volume of liquid, each reservoir having a dispensing outlet at a distal end through which a desired amount of liquid can be dispensed from the reservoir at irregular intervals determined by a user, an inlet at a proximal end, and an actuator provided at a distal end of the reservoir which when activated results in the ejection of the desired amount of liquid from the dispensing outlet.

The present invention relates to a device for transferring a plurality of droplets of a desired liquid onto one or more substrates.

Researchers in fields such as molecular biology sometimes have a need to create arrays of tens of thousands of different DNA solutions printed in known positions onto a substrate. The more compact that these arrays can be made, the more sensitive are the analyses that can be performed. The positional accuracy of the placement of these fluids, and the consistency of the amount of DNA deposited are both crucial to the scientist.

Sources of DNA solutions are often held in multi-well plastic dishes, known as microtitre plates, typically containing 96 or 384 wells, one well being used for each different solution.

According to one conventional method, a drop of the sample liquid solution is transferred from the multiwell plate onto the substrate to be printed on the tip of a pin by surface tension. The pin is generally robotically moved between the multiwell plate and the substrate to be printed, and the transfer process is repeated for each of the number of substrates to be printed with the sample liquid in question. When a single pin is used to transfer more than one type of liquid sample, it is desirable to clean the pin in some way when switching from one sample to another to prevent carry-over of one sample to the next.

Improvements in transfer speeds can be achieved by the use of multiple pins in parallel, these pins being on such a spacing that they simultaneously dip into multiple wells of the multi-well plate. Further increases in speed can be achieved by using pins with a capillary slot in the tip, such that it picks up a relatively large volume of fluid sufficient for depositing a number of droplets like a “quill” pen. In this way, transfer to multiple substrates can be achieved without robotic movements to revisit the source well between each and every droplet deposition.

Although this type of pin enjoys a simple and robust construction, it does have the disadvantage that evaporation of liquid from the open capillary slot and, more significantly, from the open source wells during a run results in a variation in the concentrations of dispensed liquid. Furthermore, the standard deviation of dispensed volume is not ideal; the density with which pins can be provided on a single tool is limited by the pitch of the wells in standard multiwell plates (typically, 9 mm or 4.5 mm); lengthy cleaning cycles may be required to eliminate carryover; and the material strength of pin tip limits the minimum deposited volume.

According to another method, fluid is transferred using a micro pump. The distal end of the micropump is dipped into the well of the multiwell plate, and either through capillary action or the application of a negative pressure to an outlet at the proximal end, fluid is drawn in through the ink jet nozzle to fill a reservoir within the pump with the sample. Typically, the next step is to blot any excess fluid off the outside of the distal end of the pump; this can interfere with the operation of the pump. The pump is then robotically moved over the substrate or substrates to be printed, and a droplet of fluid is ejected by an ink jet mechanism. This may be achieved according to any one of the known methods such as Piezo electric actuation or “bubble jet”.

Since the micro pump carries a reservoir with it, it does not need to revisit the source well between each droplet deposition, and can print onto many substrates with the minimum amount of robotic repositioning. However, once all substrates have been printed with a specific sample, the pump needs to be cleaned before it can be loaded with the next sample to be printed.

This method gives excellent performance with respect to consistency of deposited volume, and enables the transfer of relatively small deposited volumes allowing denser packing of samples. However, evaporation of solvent from the liquid source in the open multi-well plate during the run gives variation in concentrations of dispensed liquid. Furthermore, it suffers from the disadvantages that: single pump heads are relatively expensive; and lengthy cleaning cycles can be necessary to eliminate carryover. Furthermore, the fact that the outside of the pump is wetted when loading liquid from the source well can lead to problems such as unreliability and lack of control of particulates in the printed sample.

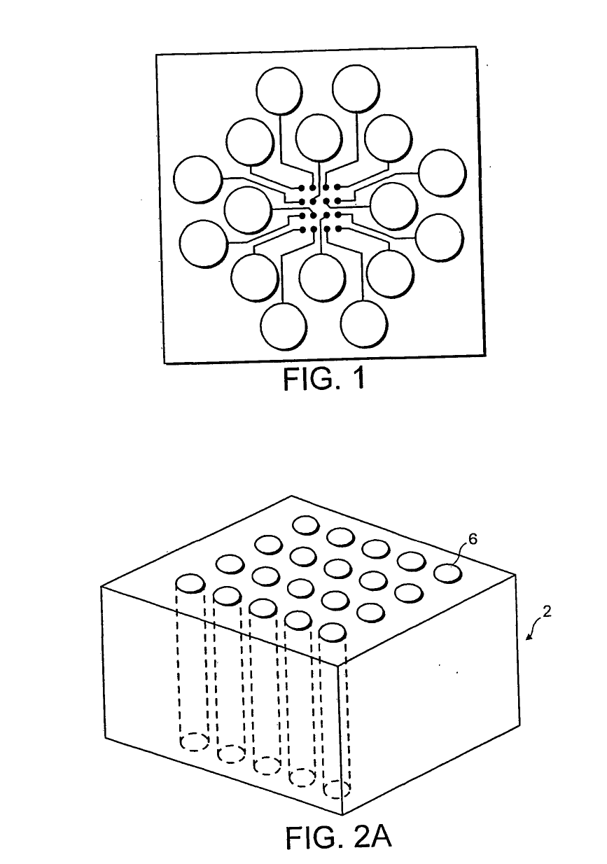

Another method uses a micro system such as the one shown in FIG. 1. In FIG. 1, the large circles represent wells for samples, which are sealed by a plastic sheet with a tiny hole to allow equalisation of pressure. These wells typically have a diameter of the order of 3-4 mm across. These wells on the top side of the device are connected by channels to a different orifice on the under side of the device. A single pneumatic actuator is used to strike the topside of the device, whereby droplets are simultaneously ejected from all of the orifices on the underside.

This method has the advantages that cleaning may not be necessary as one print channel can be provided per sample. However, it suffers from the disadvantages that: routing becomes difficult when scaling up on a single device; different length channels have different flow resistances resulting in different droplet volumes; and individual samples are not independently addressable whereby it is not possible to eject droplets from one or more selected orifices without also ejecting droplets from the others.

It is an aim of the present invention to provide a liquid storage and transfer device, which at least partially overcomes the problems with the above-described prior art devices.

According to a first aspect of the present invention, there is provided a liquid storage and transfer device for storing and transferring a plurality of liquid droplets to one or more substrates, the device comprising a plurality of reservoirs for holding a respective volume of liquid, each reservoir having a dispensing outlet at a distal end through which a desired amount of liquid can be dispensed from the reservoir at irregular intervals determined by a user, an inlet at a proximal end, and an actuator provided at a distal end of the reservoir which when activated results in the ejection of the desired amount of liquid from the dispensing outlet.

Each actuator is preferably independently addressable. It is thus possible to independently eject a droplet of desired volume from the dispensing outlet of any one of the reservoirs without ejecting droplets from the dispensing outlets of the other reservoirs.

According to a second aspect of the present invention, there is provided a liquid storage and transfer device for storing and transferring a plurality of liquid droplets to one or more substrates, the device comprising a plurality of reservoirs for holding a respective volume of liquid, each reservoir having a dispensing outlet at a distal end through which a desired amount of liquid can be dispensed from the reservoir at irregular intervals determined by a user, and an inlet at a proximal end, wherein each reservoir has the same internal shape and capacity and the distance between inlets of adjacent reservoirs is substantially the same as the distance between the dispensing outlets of said adjacent reservoirs.

The feature that each reservoir has the same internal shape and capacity and are arranged such that the distance between adjacent inlets is substantially the same as the distance between adjacent dispensing outlets has the advantage that the flow resistances in each reservoir will be substantially equal allowing the ejection of substantially uniform droplet volumes from each dispensing outlet.

Preferably, each inlet is sealed so as to substantially prevent liquid vapour from escaping from the reservoir via the inlet whilst allowing equalisation of pressure between the atmosphere outside the reservoir and that inside the reservoir. Each reservoir encloses a volume of liquid in the sense that it has no inlets or outlets other than the dispensing outlet and the sealed inlet, in order to prevent any liquid that may evaporate within the reservoir from undesirably escaping from the reservoir.

The reservoir may in some embodiments comprise a main liquid storage portion of relatively large capacity connected to the dispensing outlet by means of a connecting portion of relatively narrow capacity for holding a volume of liquid to be dispensed upon activation of the actuator. In such an embodiment, the actuator may be provided between the main liquid storage portion and connecting portions of the reservoir.

In one embodiment, the dispensing outlet has a diameter in the range of 1 to 50 μm; the reservoir has a capacity in the range of 1 to 20 μL; and the inlet has a diameter in the range of 100-2000 μm.

The devices of the present invention may be used repeatedly by refilling each reservoir with the same or a different liquid. However, one advantage of the devices of the present invention is that they may be disposable in the sense that they may be manufactured at a relatively low cost such that it becomes economically feasible to discard each device after the reservoirs become depleted for the first time and then using a new device filled with the same liquid or different liquid, thereby avoiding risks of contamination.

According to a third aspect of the present invention, there is provided a use of the above-described liquid storage and transfer device for the long-term storage of a liquid containing a biomaterial, such as a solution of DNA or a protein, and the transfer of droplets of such liquid to a substrate.

According to a fourth aspect of the present invention, there is provided a method of producing a liquid storage and transfer device comprising the steps of: (a) providing an integrated structure having formed therein a throughhole extending from a first surface to an opposite second surface of the integrated structure, the throughhole constituting in the final device the main body of a liquid reservoir; (b) providing an actuator structure on the first surface of the integrated structure such that an actuator is located over the opening of the throughhole, the actuator serving, in the final device, as means for the controlled ejection of a droplet of desired volume from a source of liquid stored in the throughhole; and (c) providing a nozzle structure on a surface of the actuator structure opposite the integrated structure such that an outlet nozzle is located over the opening of the throughhole, the nozzle serving in the final device as a dispensing outlet for liquid stored in the throughhole.

According to a fifth aspect of the present invention, there is provided a method of producing a liquid storage and transfer device comprising the steps of: (a) providing an integrated structure having formed therein a plurality of throughholes extending from a first surface to an opposite second surface of the integrated structure, each throughhole constituting in the final device the main body of a respective liquid reservoir; (b) providing an actuator structure on the first surface of the integrated structure such that an actuator is located over the opening of each throughhole, the actuator serving, in the final device, as means for the controlled ejection of a droplet of desired volume from a source of liquid stored in the respective throughhole; and (c) providing a nozzle structure on a surface of the actuator structure opposite the integrated structure such that an outlet nozzle is located over the opening of each throughhole, each nozzle serving in the final device as a dispensing outlet for liquid stored in the respective throughhole.

These methods have the advantage that they can be used to produce a large number of devices relatively quickly and cost-effectively. This allows the devices to be manufactured as disposable devices that are intended to be disposed of after a single use once the liquid in the reservoirs has run out. A main advantage of employing a brand new device for a subsequent use rather than cleaning and re-filling a used device is that there is no concern of contamination by a material different to the one to be employed in the subsequent use.

The plurality of throughholes and nozzle outlets preferably have a uniform capacity and internal shape. The plurality of throughholes are preferably arranged in parallel with respect to one another. In a preferred embodiment, the distance between adjacent throughhole openings on the second surface is substantially equal to the distance between adjacent nozzle outlets on the surface of the nozzle structure opposite the actuator structure.

The method preferably further comprises the step of filling the throughholes with a liquid and then providing a sealing layer over the second surface of the integrated structure, the sealing layer capable of substantially preventing the escape of liquid vapour from the throughholes whilst allowing liquid to be dispensed from the throughholes upon activation of the respective actuators.

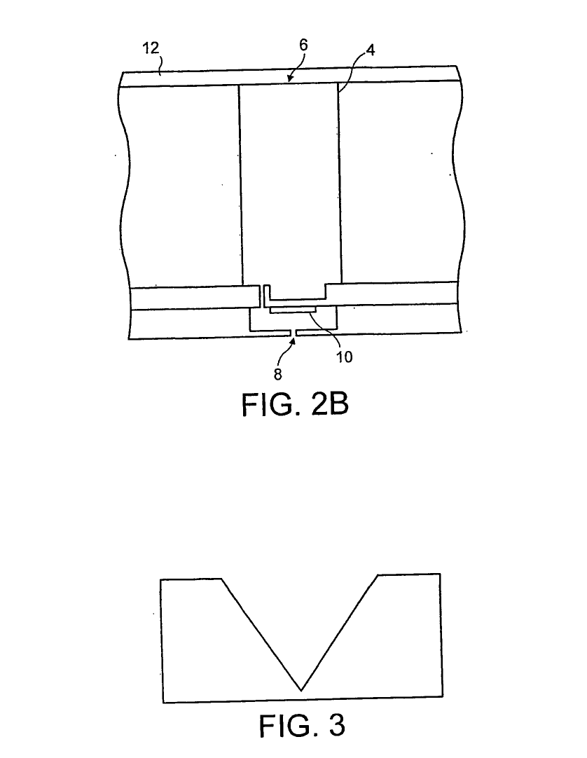

An embodiment of the present invention is described hereunder, by way of example only, with reference to FIGS. 2 to 6 of the accompanying drawings, in which:

FIG. 1 is a diagram showing a conventional device for transferring a plurality of droplets to a substrate;

FIG. 2(a) shows a perspective view of a liquid transfer device according to the present invention, and FIG. 2(b) shows a cross-sectional view of each of the reservoirs of the device shown in FIG. 2(a);

FIG. 3 is a cross-sectional view of a nozzle outlet at an intermediate stage in its production in a method of producing a liquid storage and transfer device according to the present invention;

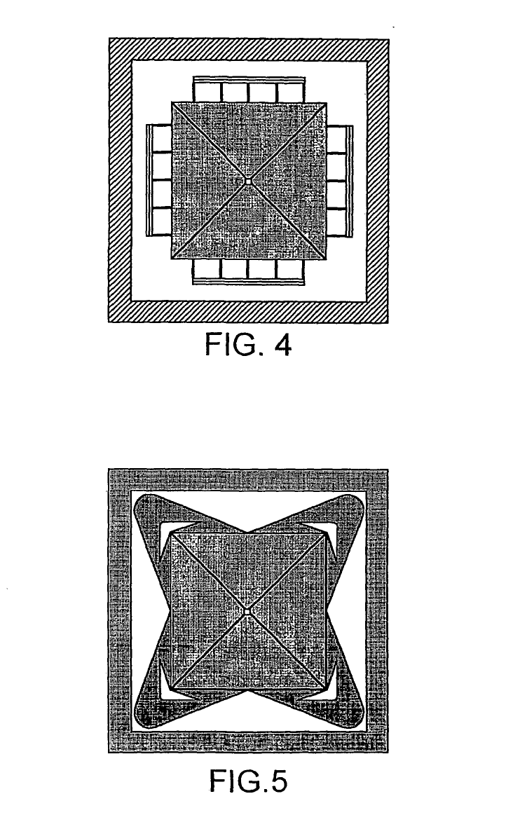

FIGS. 4 and 5 are plan views of examples of nozzle structures for use in the method of the present invention; and

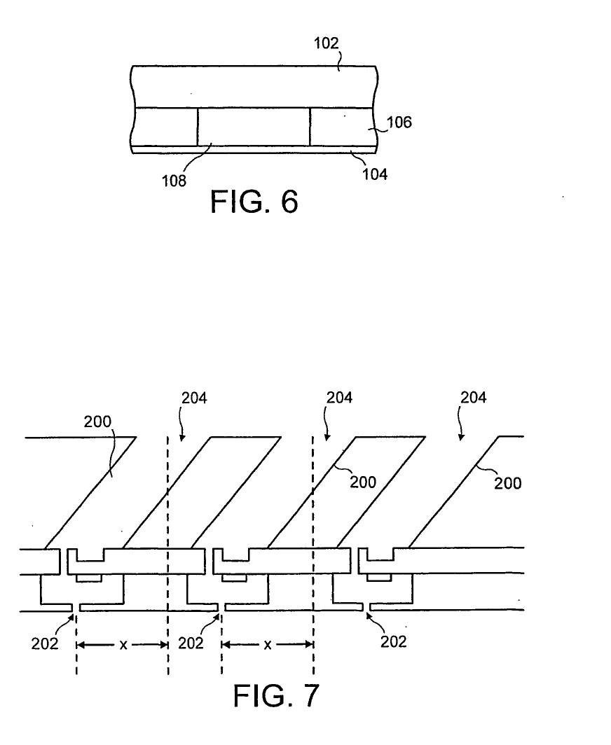

FIG. 6 is a cross-sectional view of an actuator for use in the device and method of the present invention.

The liquid transfer device 2 shown in FIGS. 2(a) and 2(b) comprises a series of substantially cylindrical reservoir channels 4 formed in parallel in, for example, a block of solid stainless steel or polycarbonate. The parallel arrangement of the channels is shown by dotted lines for the first row of channels in FIG. 2(a). Each of the channels 4 has an inlet 6 at the top face of the device which is preferably large enough to permit the channel to be loaded with a desired liquid using commonly available equipment such as a pipette. The pitch of the inlets is typically about 1 mm. Each of the channels 4 further has a narrow outlet nozzle 8 at the bottom face of the device which is in-line with the respective reservoir channel in the sense that the outlet nozzle lies directly below the inlet of the respective reservoir channel when the device is in use. Each outlet nozzle 8 is narrow enough to prevent liquid from freely flowing out of the reservoir under the influence of gravity alone, but which permits a desired volume of the liquid in the channel to be dispensed when the Piezo electric actuator 10 is activated. The diameter of the outlet nozzles is typically designed to give a spot diameter of 50 microns. A suitable diameter of the outlet nozzles is about 20 microns. The pitch of the outlet nozzles 8 is the same as the pitch of the inlets 6 i.e. typically about 1 mm. This has the added advantage that complex ducting can be avoided.

The internal shape and volume of each reservoir channel (including the outlet nozzle) is substantially identical such that the flow conditions through each output nozzle are uniform for each channel. This results in good uniformity of dispensed droplet volume across the plurality of channels.

According to a preferred embodiment of a method of producing this liquid storage and transfer device according to the present invention, a series of throughholes are formed in a solid block of stainless steel or polycarbonate to provide an integrated series of cylindrical reservoir channels as shown in FIG. 2a. An actuator plate is produced separately comprising a plurality of individual actuators provided in an array matching the array of reservoir channels. A nozzle plate is also produced separately comprising a plurality of individual outlet nozzles provided in an array matching the array of throughholes and the array of actuators of the actuator plate. These three components are then assembled together with the actuator plate sandwiched between the block of reservoir channels and the nozzle plate such that each reservoir channel lines up with an actuator and an outlet nozzle.

In the embodiment described above, the narrow outlet nozzle 8 at the bottom face of the device is in-line with the inlet of the respective reservoir channel in the sense that the outlet nozzle lies directly below the inlet of the respective reservoir channel when the device is in use. However, in one variation, each reservoir channel 200 is shaped, as for example shown in cross-section in FIG. 7. Each reservoir still has a common internal shape and capacity and the distance between inlets of adjacent reservoirs is still substantially the same as the distance between the respective outlet nozzles 202, but the 204 inlet of each reservoir channel 200 is horizontally offset from the respective outlet nozzle 202 by a common distance X. Such an offset between the inlet of each reservoir and the outlet of the respective nozzle may also be achieved with a vertically aligned reservoir. The nozzle plate is positioned such that each outlet nozzle is offset from the respective throughhole in the actuator plate, and narrow channels are formed between the nozzle plate and the actuator layer to connect each outlet nozzle with the respective throughhole.

A method of fabricating each of the three components is described below.

Nozzle Plate

The following is an example of a method for fabricating the dispensing nozzle plate. Alternative designs include (a) ones having a protruding exit nozzle to minimise droplet deflection on ejection from the nozzle through asymmetrical wetting angles occurring because of reagent residue on the nozzle rim; and (b) ones having a non-wetting surface around the nozzle structure so that the wetting angle and indeed area of surface that is wetted is tightly controlled, again to minimise droplet deflection.

A 400 μm thick piece of silicon is polished with its [100] axis normal to its top and bottom surface. The polishing is required to ensure the top and bottom surfaces are highly parallel. A 537 μm wide square of the silicon is crystallographically etched with KOH (potassium hydroxide). This method will preferentially attack the silicon in the [111] planes thereby etching an inverted pyramid shape in the silicon to a depth of 380 μm at its vertex. A cross-sectional view of the resulting structure is shown in FIG. 3.

On the top surface is etched a liquid channel, either crystallographically or using dry etching techniques. This will allow liquid to enter the pressure chamber from the respective reservoir channel. The size and shape of the liquid channel are suitably designed to minimise the reverse flow of liquid out of the pressure chamber and into the reservoir when the actuator is energised. Examples of such shapes are shown in FIGS. 4 and 5.

This is followed by dry etching or laser micromachining through the bottom of the pressure chamber to allow well-defined quantities of liquid to escape when the respective actuator is energised in the final device.

Actuator

Examples of actuators which could be used in the liquid storage and transfer device include shape memory allow, electromagnetic, pneumatic, hydraulic, electrostatic and phase change (e.g. ‘bubble jet’) types. A Piezo-electric actuator is preferred because of its biocompatibility. The Piezo-electric actuator could be used in either thickness mode, where the Piezo is used to directly strain in the same direction as the applied electric field, or in flexural/bending mode, where its strain causes a bending moment either in itself or an attached membrane. For simplicity of fabrication and because the properties of piezos are more consistent when they are not under bending moments, a. Piezo in thickness mode is described below as a preferred actuator.

With reference to FIG. 6 which shows a cross-sectional view of an individual actuator in its final form, a 200-300 μm thick slab of metallised Piezo ceramic 108 is bonded to a 200 μm thick substrate 102 of for example stainless steel. Using a diamond saw of suitable blade thickness, the ceramic (and some of the under-lying stainless steel) is diced vertically and horizontally to leave ‘islands’ or blocks of ceramic in a regular array.

The next step is to fill-in the gaps between the Piezo elements with an insulating material 106. This could be, for example, polyamide. This also acts to stop water getting on the Piezo ceramic and electrical contacts. If the filling has been done with suitable care, the resulting structure will consist of a top surface which has a regular array of exposed top Piezo ceramic electrodes embedded in insulator.

A thin (1-50 μm) membrane of silicon 104 is then metallised on one surface. The metal side of this is then bonded onto the exposed ceramic electrodes forming a stainless steel/ceramic/silicon sandwich.

Four 150 μm holes are drilled at the corners of the actuator structure to allow liquid to transfer from one side of it (the reservoir channel side) to the other side (the nozzle side).

The final structure (the 150 μm holes are not shown) is shown in FIG. 6.

Block of Reservoir Channels

The reservoir channel structure can be constructed through many means. It can be conventionally machined, formed using LIGA and micromoulded or injection moulded. For example, a series of chambers 1-10 mm high and 100-2000 μm in width/diameter are machined into a regular pattern.

Many such dispensing units can be fabricated in a single device in a regular array at anything from 100 to 2000 microns pitch.

In use, each of the channels is loaded via the inlets 6 on the back face of the device typically with sufficient volume of liquid for many thousands of droplet depositions. Since loading is carried out from behind the ink-jet orifice, the outside of the device is not wetted. Furthermore, the deposition reliability can be further increased by providing an in-line filter between the inlet and the outlet nozzle. For example, such a filter could be provided in the outlet nozzle.

An impermeable sheet 12 provided with one or more tiny holes is then applied over each of the inlets as a sealing layer. This acts to inhibit the escape of liquid by evaporation from each channel whilst allowing sufficient pressure equalisation between the atmosphere and inside the reservoir to enable liquid to be dispensed from the output nozzle when activated. The impermeable sheet 12 could, for example, be made of stainless steel foil of thickness 50 μm having laser drilled holes of a diameter 10-20 μm, or could be a glass cover with tiny holes formed by etching. Since loss of liquid from each channel is inhibited, the device is suitable for long-term use and can therefore be loaded with relatively large volumes of liquid without any concern about the evaporation of liquid prior to deposition and the problems associated therewith. The large capacity of the device also means that it can be produced as a disposable device, which has, for example, the advantage that there is no need for the difficult and time-consuming wash steps which can be required with low-volume reusable devices. In the case of a disposable device, the impermeable sheet 12 can be applied in a permanent manner.

Alternatively, the device could be produced as a reloadable device with the impermeable sheet 12 applied such that it can be relatively readily removed from the device.

Alternatively, a semi-permeable membrane could be used instead of the impermeable sheet provided with one or more tiny holes.

As mentioned above, each of the channels is provided with a Piezoelectric actuator, which when activated creates a pressure wave within the liquid in the respective reservoir channel to eject a droplet from the outlet nozzle. Each of the Piezoelectric actuators is preferably independently addressable. This eliminates the need for complex ducting to deposit droplets on smaller pitches making the system relatively readily scalable.

In use, the device is positioned above a substrate and one or more of the Piezoelectric actuators are activated to simultaneously eject the desired array of drops onto the substrate. If all the channels were fired simultaneously, an array having a pitch the same as that of the outlet nozzles would be produced. An array of higher density array can be produced, for example, by selectively depositing from the channels and then moving the substrate relative to the device by a relatively small distance (i.e. smaller than the pitch of the outlet nozzles) before depositing again.

20. A liquid storage and transfer device comprising:
an intergrated reservoir structure having formed therein a plurality of throughholes extending from a first surface to an opposite second surface of the intergrated structure, each throughhole constituting the main body of a respective liquid reservoir;
an actuator structure on the first surface of the intergrated reservoir structure; and
a nozzle structure on a surface of the actuator structure opposite the intergrated reservoir structure such that an outlet nozzle is located over the opening of each throughhole, each nozzle serving as a dispensing outlet for liquid transfered from the respective throughhole via a respective hole defined in the actuator structure;
wherein the actuatoe structure includes an actuator located between each throughhole and the respective outlet nozzle and is adapted together with the outlet nozzle for the controlled ejection from the outlet nozzle of a droplet of relatively small volume from a
relatively large volume of liquid stored in the respective throughhole, and wherein the plurality of throughholes have a uniform capacity and internal shape, and the distance between adjacent throughhole openings on the second surface is substantially equal to the distance between outlets of adjacent outlet nozzles at the output end of the device.

21. A device according to claim 20, wherein each actuator operates by creating a pressure wave in the liquid so as to eject a droplet from the outlet nozzle.

22. A device according to claim 20 further comprising providing a sealing layer over the second surface of the integrated structure, the sealing layer being capable of substantially preventing the escape of liquid vapor from the throughholes while allowing liquid to be dispensed from the throughholes upon activation of the respective actuators.

23. A device according to claim 20, wherein each actuator is independently addressable.

24. A device according to claim 20, wherein the actuator is a piezoelectric actuator adapted to operate in bending mode and which when activated results in the ejection of the desired volume of liquid from the respective outlet nozzle.

25. A device according to claim 20, wherein the dispensing outlets lie in a common plane.

26. A device according to claim 20, wherein each dispensing outlet has a diameter in the range of 1 to 50 μm.

27. A device according to claim 26 wherein each dispensing outlet has a diameter in the range of 10 to 50 μm.

28. A device according to claim 20, wherein each throughhole has a capacity in the range of 1 to 20 μL.

29. A device according to claim 20 wherein the inlet of each throughole at the second surface of the integrated structure has a diameter in the range of 100-2000 μm.

30. A liquid transfer device according to claim 20, wherein the inlets of the plurality of throughholes are positioned in a common plane.

31. A method of producing a liquid storage and transfer device comprising:
providing an integrated reservoir structure having formed therein a plurality of throughholes extending from a first surface to an opposite second surface of the integrated structure, each throughhole constituting in the final device the main body of a respective liquid reservoir;
providing an actuator structure on the first surface of the integrated structure; and
providing a nozzle structure on a surface of the actuator structure opposite the integrated reservoir structure such that an outlet nozzle is located over the opening of each throughhole, each nozzle serving in the final device as a dispensing outlet for liquid transferred from the respective throughhole via a respective hole defined in the actuator structure;
wherein the actuator structure includes an actuator located between each throughhole and the respective outlet nozzle and is adapted together with the outlet nozzle for the controlled ejection from the outlet nozzle of a droplet of relatively small volume from a relatively large volume of liquid stored in the respective throughhole, and wherein the plurality of throughholes have a uniform capacity and internal shape, and the distance between adjacent throughhole openings on the second surface is substantially equal to the distance between outlets of adjacent outlet nozzles at the output end of the device.

32. A method according to claim 31, wherein each actuator operates by creating a pressure wave in the liquid so as to eject a droplet form the outlet nozzle.

33. A method according to claim 31 further comprising providing a sealing layer over the second surface of the integrated structure, the sealing layer capable of substantially preventing the escape of liquid vapor from the throughholes whilst allowing liquid to be dispensed from the throughholes upon activation of the respective actuators.

34. The use for the dispensing of droplets at irregular intervals of a liquid containing a biomaterial, of a liquid storage and transfer device comprising:
an integrated reservoir structure having formed therein a plurality of throughholes extending from a first surface to an opposite second surface of the integrated structure, each throughhole constituting the main body of a respective liquid reservoir;
an actuator structure on the first surface of the integrated structure; and
